(19) United States
(12) Patent Application Publication
(10) Pub. No.: US 2009/0325041 A1
(43) Pub. Date: Dec. 31, 2009

(54) Lithium Secondary Battery

(75) Inventors: Takefumi OKUMURA, Hitachinaka-shi (JP); Shigetaka Tsubouchi, Naka-gun (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/491,616

(22) Filed: Jun. 25, 2009

(30) Foreign Application Priority Data
Jun. 27, 2008 (JP) 2008-168043

(51) Int. Cl. H01M 4/60; H01M 2/34; H01M 6/16

(52) U.S. Cl. 429/61; 429/213; 429/331

(57) ABSTRACT

A lithium secondary battery is disclosed which includes: a cathode that is capable of storing/releasing a lithium ion, an anode that is capable of storing/releasing a lithium ion, a separator that separates the electrodes from each other, and an electrolyte solution. The cathode includes a cathode-active material and an electroconductive material comprised of at least one gas-generating resin that is decomposed with generation of a gas at a temperature at which oxygen is eliminated from the cathode-active material, and an electroconductive filler.

### INCORPORATION BY REFERENCE

The disclosure of the following priority application is herein incorporated by reference:

Japanese Patent Application No. 2008-168043 filed Jun. 27, 2008.

### BACKGROUND OF THE INVENTION

1. Field of the Invention

The present invention relates to a lithium secondary battery, more particularly to a lithium secondary battery that is provided with electrodes having an increased resistance at an increased temperature and a mechanism for cutting off a current that operates in response to an increase in the internal pressure of the battery.

2. Description of Related Art

Hybrid electric vehicles, in which an engine and a motor serve as power sources, have been developed and commercialized for environmental protection and energy saving. Moreover, fuel cell hybrid electric vehicles in which a fuel cell is used in place of an engine have been extensively under development for vehicles in the future.

Secondary batteries, which can undergo a number of charging/discharging cycles, are essential devices as power sources for hybrid electric vehicles.

Of secondary batteries, lithium secondary batteries are promising, because of their high operational voltage and capability of generating a high output, and are of increasing importance as power sources for hybrid electric vehicles.

On the other hand, improvement of safety is becoming more important to cope with higher energy outputs of the lithium secondary batteries.

Conventional countermeasures for safety include, for example, leakage of an increase of the internal pressure in the battery by means of a safety valve or by the incorporation of a PTC function into the battery, which function decreases a current as a result of an increase in the resistivity of the battery when heat is generated due to external short-circuiting.

For example, Patent Document 1 discloses a lithium secondary battery that includes lithium carbonate as a material enhancing the internal pressure of the battery in the positive electrode and a mechanism for cutting off a current that is put into action when the internal pressure of the battery is enhanced, the battery effectively exhibiting the effect of cutting off a current due to generation of carbon dioxide at an increased temperature in an unsteady state. Patent Document 2 discloses a battery that includes a mechanism for cutting off a current that operates when the internal pressure inside the battery has increased and also a material increasing the internal pressure of the battery, such as butoxycarbonylphenol or butoxycarbonylpyrrole, which liberates a gas upon an increase in temperature in an unsteady state to effectively exhibit a current cutting off effect.

On the other hand, Patent Document 3 discloses a technology in which an electrode provided with a positive temperature coefficient (PTC) function that prevents an increase in short-circuit current by an increased resistance of the electrode in response to heat generated by external short-circuiting is incorporated into a battery.

Patent Document 1: JP-A-04-328278

Patent Document 2: JP-B-3,623,391

Patent Document 3: JP-B-3,786,973

### SUMMARY OF THE INVENTION

However, the conventional technology in which use is made of the mechanism for cutting off a current by gas generation could not have sufficient responsiveness in exhibiting the function in response to abrupt heat generation in an unsteady state such as external short-circuiting or overcharge. The technology of incorporating the electrode provided with a PTC function into a battery suffers from deterioration of the characteristics when stored at high temperatures that are important especially for use in hybrid automobiles.

It is an object of the present invention to provide a lithium secondary battery with electrodes that secure responsiveness in exhibiting its function in an unsteady state such as external short-circuiting or overcharge without damaging the characteristics of the battery when stored at high temperatures.

According to an aspect, the present invention provides a lithium secondary battery comprising: a cathode that is capable of storing/releasing a lithium ion, an anode that is capable of storing/releasing a lithium ion, a separator that separates the electrodes from each other, and an electrolyte solution, wherein the cathode includes a cathode-active material and an electroconductive material comprised of at least one gas-generating resin that is decomposed with generation of a gas at a temperature at which oxygen is eliminated from the cathode-active material, and an electroconductive filler.

The cathode includes a cathode mixture layer and a cathode-side collector. The cathode mixture layer is a layer that is formed by spreading a cathode mixture containing a cathode-active material, an electroconductive material, and a binder on the cathode-side collector.

The anode includes an anode mixture layer and an anode-side collector. The anode mixture layer is a layer that is formed by spreading an anode mixture that contains an anode-active material, an electroconductive material, and a binder on the anode-side collector.

According to the present invention, there can be provided a highly safe lithium secondary battery that can reliably actuate a mechanism for cutting off a current in an unsteady state such as external short-circuiting or overcharge without damaging the characteristics of the lithium secondary battery.

### BRIEF DESCRIPTION OF THE DRAWING

FIG. 1 is a cross-sectional view illustrating one side of a spirally wound battery according to an embodiment of the present invention.

### DESCRIPTION OF PREFERRED EMBODIMENTS

The lithium secondary battery of the present invention comprises: a cathode that is capable of storing/releasing a lithium ion, an anode that is capable of storing/releasing a lithium ion, a separator that separates the electrodes from each other, and an electrolyte solution. The cathode includes a cathode-active material and an electroconductive material comprised of at least one gas-generating resin that is decomposed with generation of a gas at a temperature at which oxygen is eliminated from the cathode-active material and electroconductive filler. The gas generating resin in the electroconductive material comprises a gas generating resin that generates carbon dioxide upon thermal decomposition and/or a gas generating resin that reacts endothermically upon thermal decomposition.

The gas generating resin includes, for example, a polycarbonate resin represented by a compositional formula of (—X—O—(C═O)—O—)ₙ wherein X represents an alkyl group having 2 to 7 carbon atoms. Specific examples of the alkyl group represented by X include an ethyl group, a propyl group, a butyl group, or a pentyl group. The alkyl group may be substituted with fluorine, chlorine or the like. The alkyl group may be a straight chain alkyl group or a branched chain alkyl group. The suffix n represents the number of repeating units. Preferably, X is an ethyl group (X=ethyl) since the polycarbonate resin has a higher relative ratio of the carbonate group (—O—CO—O—), which is a gas generating portion. The molecular weight of the gas generating resin is selected from the range of 1,000 to 1,000,000. From the viewpoint of moldability of the electroconductive material that includes the gas generating resin and the electroconductive filler, the molecular weight of 10,000 to 500,000 is particularly preferred. When the molecular weight is no higher than 1,000, it becomes difficult to bind the electroconductive filler, so that the electroconductive material is difficult to mold. On the other hand, the molecular weight of 1,000,000 or higher is undesirable since the dispersibility of the gas generating resin in the electroconductive material is decreased, which in turn results in a decrease in its bindability. The gas generated upon the thermal decomposition of the gas generating resin is preferably a noninflammable gas in view of safety, and carbon dioxide is particularly preferred. Preferably, the gas generating resin is one that reacts endothermically when a gas is generated from the viewpoint of safety. The temperature at which a gas is generated from the gas generating resin (hereafter, gas generation temperature) is preferably no higher than the temperature at which oxygen is eliminated from the cathode-active material and particularly preferably 50° C. or higher and 200° C. or lower. The gas generation temperature of 50° C. or lower is undesirable since a gas tends to be generated from the gas generating resin upon storage at high temperatures, thus causing deterioration of the performance of the battery. On the other hand, the gas generation temperature of 200° C. or higher is also undesirable since there tends to occur elimination of oxygen in the cathode-active material before the gas can be sufficiently generated, so that a current cutting off valve will not sufficiently operate.

Examples of the electroconductive filler include carbon materials such as carbon black, graphite, carbon fiber, and metal carbides. They may be used alone or two or more of them may be used in combination with each other. The ratio of the electroconductive filler in the electroconductive material is preferably 40 to 80 parts by mass. The ratio of no more than 40 parts by mass is undesirable since there can be secured only insufficient electroconductivity so that the resistance of the electrode is increased. On the other hand, the ratio of no less than 80 parts by mass is also undesirable since the ratio of the gas generation resin in the electroconductive material is decreased, making it difficult to operate the current cutting off valve reliably.

The electroconductive material includes the gas generating resin and the electroconductive filler. The method of preparing the electroconductive material is not particularly limited. For example, it can be prepared by a method of kneading and palletizing the electroconductive filler and the gas generating resin and then pulverizing the resultant pellets in a jet mill, a ball mill or the like.

The cathode is fabricated by coating or spreading a cathode mixture including the cathode-active material, the electroconductive material, and the binder over an aluminum foil, which serves as a collector, to form the cathode mixture layer. An electroconductive agent may be added to the cathode mixture layer in order to decrease the electronic resistance thereof. The cathode-active material preferably includes lithium composite oxides represented by a compositional formula of Li_{α}MnₓM1_{y}M2_{z}O₂ (wherein M1 is at least one member selected from Co and Ni; M2 is at least one member selected from CO, Ni, Al, B, Fe, Mg, and Cr, provided that x+y+z=1, 0<α<1.2, 0.2≦x≦0.6, 0.2≦y≦0.4, and 0.05≦z≦0.4). Among them, more preferred lithium composite oxides are those compounds in which M1 is Ni or Co; and M2 is Co or Ni. A still more preferred example of the lithium composite oxide is LiMn_{1/3}Ni_{1/3}Co_{1/3}O₂. An increased amount of Ni in the composition leads to a higher capacity of the battery. An increased amount of Co in the composition leads to an improvement in outputs at low temperatures. An increased amount of Mn in the composition leads to a reduction in cost of the material. The additive elements are effective for stabilizing the cycle characteristics. The cathode-active material may be orthorhombic phosphate compound having a space group symmetry of Pmnb represented by a general formula of LiMn_{X}PO₄ (wherein M is Fe or Mn, 0.01≦X≦0.4) or LiMn_{1-X}M_{X}PO₄ (where in M is a divalent cation other than Mn, 0.01≦X≦0.4). In particular, LiMn_{1/3}Ni_{1/3}Co_{1/3}O₂ has improved low-temperature characteristics and improved cycle stability and is suitable as a material for lithium batteries for use in hybrid electric vehicles (HEV). The binder is not limited particularly as far as it can bring the material that constitutes the cathode and the cathode-side collector into close contact. Examples of the binder include homopolymers and copolymers of vinylidene fluoride, tetrafluoroethylene, acrylonitrile, ethyleneoxide and so on as well as styrene-butadiene rubber. The electroconductive agent may include carbon materials, for example, carbon black, graphite, carbon fiber, and metal carbides. They may be used alone or two or more of them may be used in combination with each other.

The anode is fabricated by spreading an anode mixture over a copper foil, which is a collector, to form an anode mixture layer thereon. An electroconductive agent may be added to the anode mixture layer in order to decrease electronic resistance. The anode-active materials useful for the present invention include, for example, natural graphite, composite carbonaceous materials with natural graphite coated with a film formed by a dry CVD (Chemical Vapor Deposition) method or a wet spraying method, synthetic graphite produced by sintering a resin such as epoxy or phenol or a pitch from petroleum or coal; other carbonaceous materials such as amorphous carbon materials; lithium metal having a capability of storing/releasing lithium by forming a compound with lithium; oxides or nitrides of the elements belonging to the IV group such as silicon, germanium, or tin, capable of reacting with lithium to form a compound that can be held in the interstices between the crystals to have a capability of storing/releasing lithium. They may be generally referred to as anode-active materials. In particular, a carbonaceous material is an excellent material because of its high electroconductivity, low-temperature characteristics and good cycle stability. Of carbonaceous materials, those having a wide interlayer space between carbon network planes (d₀₀₂) are suitable for their rapid charging/discharging capability and excellent low-temperature characteristics. It should be noted, however, that some carbonaceous materials having a wide d₀₀₂ value show insufficient capacity or charging/discharging efficiency during the initial stage of charging, and hence they preferably have a d₀₀₂ value of 0.39 nm or less. Such a material may be sometimes referred to as pseudo-anisotropic carbon. Moreover, the electrode may be incorporated with a highly electroconductive carbonaceous material, e.g., graphite-like material, amorphous material or activated carbon. Graphite-like materials useful for the present invention include those having one of the following characteristics (1) to (3):

(1) an R value, or I_{D}/I_{G} ratio, of 0.2 to 0.4, inclusive, wherein I_{D} is intensity of the peak in a range from 1,300 to 1,400 cm⁻¹, and I_{G} is intensity of the peak in a range from 1,580 to 1,620 cm⁻¹, both in a Raman spectral pattern,
(2) a half width Δ of 40 to 100 cm⁻¹, inclusive, of the peak in a range from 1,300 to 1,400 cm⁻¹ in a Raman spectral pattern, and
(3) an X value, or I(₁₁₀)/I(₀₀₄) ratio, of 0.1 to 0.45, inclusive, wherein I(₁₁₀) is peak intensity from the (110) plane and I(₀₀₄) is peak intensity from the (004) plane, both in an X-ray diffraction pattern.

The binder is not particularly limited as far as it allows for intimate contact between the material that constitutes the anode and the anode-side collector. Examples of the binder include homopolymers or copolymers of vinylidene fluoride, tetrafluoroethylene, acrylonitrile, and ethylene oxide as well as styrene-butadiene rubber. The electroconductive agents include carbon materials, for example, carbon black, graphite, carbon fiber, and metal carbides. They may be used alone or in combination of two or more of them.

The electrolyte solution includes a solvent and a lithium salt. The solvent includes a cyclic carbonate represented by the formula (I)

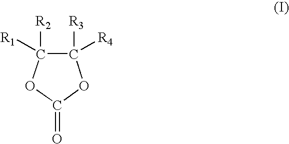

(wherein R₁, R₂, R₃ and R₄ may be the same or different and are each hydrogen, fluorine, chlorine, an alkyl group having 1 to 3 carbons or a fluorinated alkyl group having 1 to 3 carbons),

a linear carbonate represented by the formula (II):

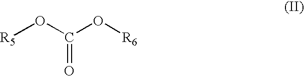

(wherein R₅ and R₆ may be the same or different and are each hydrogen, fluorine, chlorine, an alkyl group having 1 to 3 carbons or a fluorinated alkyl group having 1 to 3 carbons), and

a compound represented by the formula (III):

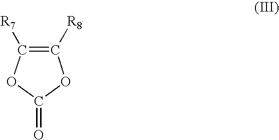

(wherein R₇ and R₈ may be the same or different and are each hydrogen, fluorine, chlorine, an alkyl group having 1 to 3 carbons or a fluorinated alkyl group having 1 to 3 carbons), and

the composition ratio of the cyclic carbonate represented by the formula (I) is 18.0 to 30.0%, the composition ratio of the linear carbonate represented by the formula (II) is 74.0 to 81.9% and the composition ratio of the compound represented by the formula (III) is 0.1 to 1.0%, based on the whole solvents (100%), all percentages by volume.

The solvents represented by the formula (I) include ethylene carbonate (EC), trifluoropropylene carbonate (TFPC), chloroethylene carbonate (ClEC), trifluoroethylene carbonate (TFEC), difluoroethylene carbonate (DFEC) and vinyl ethylene carbonate (VEC). Of the above compounds, EC is more preferable, viewed from formation of a coating film on the anode. Incorporation of a small quantity (2% by volume or less) of CLEC, TFEC or VEC imparts good cycle characteristics to a coating film on the electrode. Moreover, TFPC or DFEC may be incorporated in a small quantity (2% by volume or less) for facilitating formation of a coating film on the cathode. The solvents represented by the formula (II) include dimethyl carbonate (DMC), ethylmethyl carbonate (EMC), diethyl carbonate (DEC), methyl propyl carbonate (MPC), ethyl propyl carbonate (EPC), trifluoromethyl ethyl carbonate (TFMEC) and 1,1,1-trifluoroethyl methyl carbonate (TFEMC). DMC is highly compatible with many solvents, and is suitable for being mixed with EC or the like. DEC has a lower melting point than DMC, and is suitable for improving low-temperature (−30° C.) characteristics. EMC has an asymmetric structure and also a low melting point, and is suitable for improving the low-temperature characteristics of the battery. EPC and TFMEC have a propylene side chain and asymmetric structure, and are suitable as solvents for adjusting the low-temperature characteristics of the battery. TFEMC has a molecule partly fluorinated to have an increased dipole moment, and is suitable for keeping dissociation of lithium salts at low temperatures and also for improving the low-temperature characteristics of the battery. The compounds represented by the formula (III) include vinylene carbonate (VC), methylvinylene carbonate (MVC), dimethylvinylene carbonate (DMVC), ethylvinylene carbonate (EVC) and diethylvinylene carbonate (DEVC). VC has a low molecular weight, and is considered to form a dense coating film on the electrode. MVC, DMVC, EVC, DEVC or the like is a VC substituted with an alkyl group and is considered to form a low-density coating film on the electrode, magnitude of density depending on the size of the alkyl chain with which the compound is substituted, thus to have the effect of improving low-temperature characteristics of the battery. The lithium salt for the electrolyte solution is not limited. The lithium salts useful for the present invention include inorganic lithium salts, e.g., LiPF₆, LiBF₄, LiClO₄, LiI, LiCl and LiBr; and organic lithium salts, e.g., LiB[OCOCF₃]₄, LiB[OCOCF₂CF₃]₄, LiPF₄(CF₃)₂, LiN(SO₂CF₃)₂ and LiN(SO₂CF₂CF₃)₂. In particular, LiPF₆, which has been widely used for batteries for domestic purposes, is a suitable compound because of its quality stability. Moreover, LiB[OCOCF₃]₄ is an effective compound, because it exhibits high dissociation capability and solubility, and also high conductivity even at a low content.

As mentioned above, the lithium secondary battery described above as one embodiment of the present invention has improved safety over conventional lithium secondary batteries with securing responsiveness to exhibiting the function in an unsteady state such as external short-circuiting or overcharge, while not deteriorating output characteristics during storage at high temperatures over an extended period. As such, it can find wide use in various areas, e.g., power sources for hybrid electric vehicles, and power sources including back-up power sources for electrically driven control systems for vehicles. Moreover, it is also suitable as a power source for industrial machines, e.g., electrically driven tools and forklifts.

The best mode for carrying out the present invention is specifically described by Examples.

### EXAMPLE 1

### Preparation of Electroconductive Materials

Carbon black (70 parts by mass) as an electroconductive agent and polyethylene carbonate (30 parts by mass) as a gas generating resin were mixed to prepare pellets. The pellets were pulverized by jet milling to obtain an electroconductive material (DD1).

Fabrication of a Spirally Wound Battery

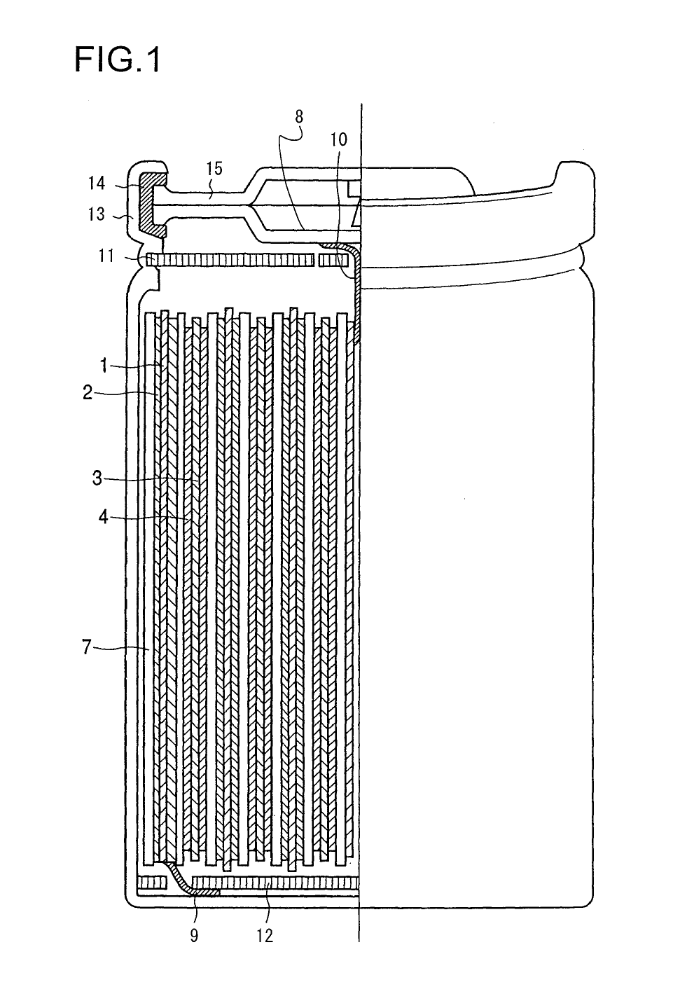

A spirally wound battery according to the present embodiment was fabricated by the following method. FIG. 1 is a cross-section illustrating one side of a spirally wound battery.

A cathode material paste was prepared by mixing LiMn_{1/3}Ni_{1/3}Co_{1/3}O₂ as a cathode-active material, DD1 as an electroconductive material, polyvinylidene fluoride (PVDF) as a binder, and NMP (N-methylpyrrolidone) as a solvent such that the ratio of solids on dry basis was LiMn_{1/3}Ni_{1/3}Co_{1/3}O₂:DD1:PVDF=88:5:7.

The paste of the cathode material was spread over an aluminum foil that served as a cathode collector 1 and dried at 80° C., roll-pressed, and dried at 120° C. to form a cathode mixture layer 2 on the cathode-side collector 1.

Then, an anode material paste was prepared by mixing pseudo-anisotropic carbon, which was amorphous carbon, as an anode-active material, carbon black (CB2) as an electroconductive material, PVDF as a binder, and NMP as a solvent such that pseudo-anisotropic carbon:CB2:PVDF=88:5:7.

The anode material paste was spread over a copper foil that served as an anode-side collector 3, dried at 80° C., roll-pressed, and dried at 120° C. to form a cathode mixture layer 4 on the anode-side collector 3.

A mixture of solvents in a composition ratio of EC:VC:DMC:EMC=19.4:0.6:40:40 by volume was used as an electrolyte solution and LiPF₆ as a lithium salt was dissolved therein in a concentration of 1 M.

A separator 7 was placed between the cathode and anode prepared above to form a spirally wound assembly, which was encased in an anode battery can 13. In order to collect electricity form the anode, one end of an anode lead 9 made of nickel was welded to the anode-side collector 3 and the other end of the anode lead 9 was welded to the anode battery can 13. On the other hand, in order to collect electricity from the cathode, one end of a cathode lead 10 made of aluminum was welded to a cathode-side collector 1. The other end of the cathode lead 10 was welded to a current cutting off valve 8 and further electrically connected to a cathode lid 15 through the current cutting off valve 8. An electrolyte solution was injected into the assembly and sealed by caulking to form a spirally wound battery.

The other components shown in FIG. 1 are 11: cathode insulator, 12: anode insulator, 14: gasket, 15, cathode battery lid 15.

Evaluation of Battery

The spirally wound battery illustrated in FIG. 1 was evaluated for direct current resistance (DCR) at 25° C. and −30° C., and pulse cycle characteristics (characteristics after the battery was subjected to pulse cycles for 1,000 hours) at 25° C. and −30° C. The evaluation results are shown in Table 1.

The battery was charged with electricity at a constant current of 0.7 A to 4.1 V, and then at a constant voltage of 4.1 V until the amperage reached 20 mA. Then, it was allowed to discharge electricity to 2.7 V at 0.7 A, after it was halted for 30 minutes. These cycles were repeated 3 times.

Next, the battery was charged with electricity at a constant current of 0.7 A to 3.8 V, allowed to discharge electricity at 10 A for 10 seconds, again charged with electricity to 3.8 V at a constant current, allowed to discharge electricity at 20 A for 10 seconds, again charged with electricity to 3.8 V, and allowed to discharge electricity at 30 A for 10 seconds.

The battery was evaluated for DCR based on the I-V characteristics observed.

Moreover, the battery was subjected to a pulse cycle test in which charging/discharging were repeated at 20 A for 2 seconds in a constant-temperature bath kept at 50° C., and evaluated for DCR at 25° C. and −30° C., after it was subjected to the pulse cycles for 1,000 hours. The evaluation results are given in Table 1.

TABLE 1

| | | | | | | | | | | | | Characteristics | |
|---|---|---|---|---|---|---|---|---|---|---|---|---|---|
| | | | | | | | | | | | | after 1,000 pulse | |
| | | | | | | | | | | Initial | | cycles | |
| | Electroconductive | | | | | | | | | Characteristics | | Output | Output |
| | Material | | | | Cathode | | | | Occurrence | DCR | DCR | retention | retention |
| | (Parts by mass) | | | | (% by mass) | | | | of damaged | @25° C. | @−30° C. | ratio | ratio |
| | CB¹⁾ | PEC²⁾ | PVDF³⁾ | PE⁴⁾ | AM⁵⁾ | ECM⁶⁾ | BD⁷⁾ | ECA⁸⁾ | product | (mΩ | (mΩ) | @25° C. (%) | @−30° C. (%) |
| Example 1 | 70 | 30 | 0 | 0 | 88 | 5 | 7 | 0 | No | 68 | 613 | 82 | 81 |
| Example 2 | 70 | 25 | 5 | 0 | 88 | 5 | 7 | 0 | No | 67 | 605 | 83 | 82 |
| Example 3 | 70 | 20 | 10 | 0 | 88 | 5 | 7 | 0 | No | 67 | 598 | 85 | 81 |
| Example 4 | 70 | 30 | 0 | 0 | 83 | 5 | 7 | 5 | No | 65 | 595 | 85 | 82 |
| Example 5 | 70 | 25 | 5 | 0 | 83 | 5 | 7 | 5 | No | 64 | 593 | 86 | 85 |
| Example 6 | 70 | 20 | 10 | 0 | 83 | 5 | 7 | 5 | No | 63 | 590 | 87 | 85 |
| Comparative | 0 | 0 | 0 | 0 | 88 | 0 | 7 | 5 | Yes | 68 | 675 | 83 | 82 |
| Example 1 | | | | | | | | | | | | | |
| Comparative | 70 | 0 | 0 | 30 | 88 | 5 | 7 | 0 | No | 68 | 710 | 72 | 69 |
| Example 2 | | | | | | | | | | | | | |
| Comparative | 70 | 0 | 0 | 30 | 83 | 5 | 7 | 5 | No | 75 | 680 | 68 | 67 |
| Example 3 | | | | | | | | | | | | | |

Notes:
¹⁾CB: Carbon black;
²⁾PEC: Polyethylene carbonate;
³⁾PVDF: Polyvinylidene fluoride;
⁴⁾PE: Polyethylene;
⁵⁾AM: Active material;
⁶⁾ECM: Electroconductive material;
⁷⁾BD: Binder;
⁸⁾ECA: Electroconductive agent

Safety Evaluation

Fifty batteries were fabricated and overcharged with current at 0.7 A and the degree of occurrence of damaged batteries by heat generation accompanied by an abrupt increase in temperature or an abrupt damage was evaluated. The evaluation results are shown in Table 1.

### EXAMPLE 2

Carbon black (70 parts by mass) as an electroconductive agent, polyethylene carbonate (25 parts by mass) as a gas generating resin, and PVDF (5 parts by mass) as a binder were mixed to prepare pellets. The pellets were pulverized by jet milling to obtain an electroconductive material (DD2). Batteries were fabricated in the same manner as in Example 1 by using the electroconductive material DD2 instead of the electroconductive material DD1. Battery evaluation and safety evaluation were performed on the obtained batteries in the same manner as in Example 1. The results are shown in Table 1.

### EXAMPLE 3

Carbon black (70 parts by mass) as an electroconductive agent, polyethylene carbonate (20 parts by mass) as a gas generating resin, and PVDF (10 parts by mass) as a binder were mixed to prepare pellets. The pellets were pulverized by jet milling to obtain an electroconductive material (DD3). Batteries were fabricated in the same manner as in Example 1 by using the electroconductive material DD3 instead of the electroconductive material DD1. Battery evaluation and safety evaluation were performed on the obtained batteries in the same manner as in Example 1. The results are shown in Table 1.

### EXAMPLE 4

A cathode material paste was prepared by mixing LiMn_{1/3}Ni_{1/3}Co_{1/3}O₂ as a cathode-active material, DD1 as an electroconductive material, polyvinylidene fluoride (PVDF) as a binder, a mixture of graphite and carbon black (at a mixing ratio of 5:1 by mass) as an electroconductive agent, and NMP (N-methylpyrrolidone) as a solvent such that the ratio of solids on dry basis was LiMn_{1/3}N_{1/3}Co_{1/3}O₂:DD1:PVDF: electroconductive agent=83:5:7:5. Batteries were fabricated in the same manner as in Example 1 by using the obtained cathode material paste. Battery evaluation and safety evaluation were performed on the obtained batteries in the same manner as in Example 1. The results are shown in Table 1.

### EXAMPLE 5

A cathode material paste was prepared by mixing LiMn_{1/3}Ni_{1/3}Co_{1/3}O₂ as a cathode-active material, DD2 as an electroconductive material, polyvinylidene fluoride (PVDF) as a binder, a mixture of graphite and carbon black (at a mixing ratio of 5:1 by mass) as an electroconductive agent, and NMP (N-methylpyrrolidone) as a solvent such that the ratio of solids on dry basis was LiMn_{1/3}Ni_{1/3}Co_{1/3}O₂:DD2:PVDF: electroconductive agent=83:5:7:5. Batteries were fabricated in the same manner as in Example 1 by using the obtained cathode material paste. Battery evaluation and safety evaluation were performed on the obtained batteries in the same manner as in Example 1. The results are shown in Table 1.

### EXAMPLE 6

A cathode material paste was prepared by mixing LiMn_{1/3}Ni_{1/3}Co_{1/3}O₂ as a cathode-active material, DD3 as an electroconductive material, polyvinylidene fluoride (PVDF) as a binder, a mixture of graphite and carbon black (at a mixing ratio of 5:1 by mass) as an electroconductive agent, and NMP (N-methylpyrrolidone) as a solvent such that the ratio of solids on dry basis was LiMn_{1/3}Ni_{1/3}Co_{1/3}O₂:DD3:PVDF: electroconductive agent=83:5:7:5. Batteries were fabricated in the same manner as in Example 1 by using the obtained cathode material paste. Battery evaluation and safety evaluation were performed on the obtained batteries in the same manner as in Example 1. The results are shown in Table 1.

### Comparative Example 1

A cathode material paste for a comparative cathode was prepared by mixing LiMn_{1/3}Ni_{1/3}Co_{1/3}O₂ as a cathode-active material, polyvinylidene fluoride (PVDF) as a binder, a mixture of graphite and carbon black (at a mixing ratio of 5:1 by mass) as an electroconductive agent, and NMP (N-methylpyrrolidone) as a solvent such that the ratio of solids on dry basis was LiMn_{1/3}Ni_{1/3}Co_{1/3}O₂:PVDF: electroconductive agent=88:7:5. Batteries were fabricated in the same manner as in Example 1 by using the obtained cathode material paste. Battery evaluation and safety evaluation were performed on the obtained batteries in the same manner as in Example 1. The results are shown in Table 1.

### Comparative Example 2

Carbon black (70 parts by mass) as an electroconductive agent and polyethylene (30 parts by mass) as a gas generating resin were mixed to prepare pellets for a comparative electroconductive material. The pellets were pulverized by jet milling to obtain an electroconductive material (DDR1).

A cathode material paste for a comparative cathode was prepared by mixing LiMn_{1/3}Ni_{1/3}Co_{1/3}O₂ as a cathode-active material, DDR1 as an electroconductive material, polyvinylidene fluoride (PVDF) as a binder, and NMP (N-methylpyrrolidone) as a solvent such that the ratio of solids on dry basis was LiMn_{1/3}Ni_{1/3}Co_{1/3}O₂:DDR1:PVDF=88:5:7. Batteries were fabricated in the same manner as in Example 1 by using the obtained cathode material paste. Battery evaluation and safety evaluation were performed on the obtained batteries in the same manner as in Example 1. The results are shown in Table 1.

### Comparative Example 2

A cathode material paste was prepared by mixing LiMn_{1/3}Ni_{1/3}Co_{1/3}O₂ as a cathode-active material, DDR1 as an electroconductive material, polyvinylidene fluoride (PVDF) as a binder, a mixture of graphite and carbon black (at a mixing ratio of 5:1 by mass) as an electroconductive agent, and NMP (N-methylpyrrolidone) as a solvent such that the ratio of solids on dry basis was LiMn_{1/3}Ni_{1/3}Co_{1/3}O₂:DDR1:PVDF: electroconductive agent=83:5:7:5. Batteries were fabricated in the same manner as in Example 1 by using the obtained cathode material paste. Battery evaluation and safety evaluation were performed on the obtained batteries in the same manner as in Example 1. The results are shown in Table 1.

The batteries of the invention in which an electroconductive material is mixed with the cathode cause no damaged products in contrast to the batteries of Comparative Example 1 that includes no electroconductive material, so that the present invention can provide safe batteries.

As discussed above, each of Examples 1 to 6 can provide a highly safe lithium secondary battery with electrodes that secure responsiveness in exhibiting its function in an unsteady state such as external short-circuiting or overcharge without damaging the characteristics of the battery when stored at high temperatures.

It should be understood by those skilled in the art that although the foregoing description has been made on embodiments of the invention, the invention is not limited thereto and various changes and modifications may be made without departing from the spirit of the invention and the scope of the appended claims.

What is claimed is:

1. A lithium secondary battery comprising:
a cathode that is capable of storing/releasing a lithium ion,
an anode that is capable of storing/releasing a lithium ion,
a separator that separates the electrodes from each other, and
an electrolyte solution,
wherein the cathode includes a cathode-active material and an electroconductive material comprised of
at least one gas-generating resin that is decomposed with generation of a gas at a temperature at which oxygen is eliminated from the cathode-active material, and
an electroconductive filler.

2. A lithium secondary battery according to claim 1,
wherein the cathode includes a lithium composite oxide used as a cathode-active material, the lithium composite oxide being represented by a compositional formula of Li_{α}MnₓM1_{y}M2_{z}O₂ (where M1 is at least one member selected from Co and Ni; M2 is at least one member selected from CO, Ni, Al, B, Fe, Mg, and Cr, provided that x+y+z=1, 0<α<1.2, 0.2≦x≦0.6, 0.2≦y≦0.4, and 0.05≦z≦0.4).

3. A lithium secondary battery according to claim 1,
wherein the anode includes at least one selected from the group consisting of a carbonaceous material, an oxide of an element belonging to the IV group of a periodic table, and a nitride of an element belonging to the IV group of the periodic table.

4. A lithium secondary battery according to claim 1,
wherein the electrolyte solution comprises as solvents:
a cyclic carbonate represented by the formula (I) 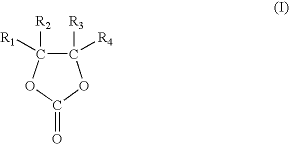
(wherein R₁, R₂, R₃ and R₄ may be the same or different and are each hydrogen, fluorine, chlorine, an alkyl group having 1 to 3 carbons or a fluorinated alkyl group having 1 to 3 carbons),
a linear carbonate represented by the formula (II): 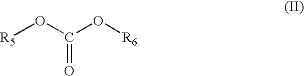
(wherein R₅ and R₆ may be the same or different and are each hydrogen, fluorine, chlorine, an alkyl group having 1 to 3 carbons or a fluorinated alkyl group having 1 to 3 carbons), and
a compound represented by the formula (III): 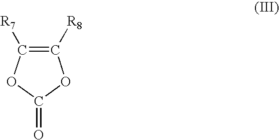
(wherein R₇ and R₈ may be the same or different and are each hydrogen, fluorine, chlorine, an alkyl group having 1 to 3 carbons or a fluorinated alkyl group having 1 to 3 carbons), and
wherein the composition ratio of the cyclic carbonate represented by the formula (I) is 18.0 to 30.0%,
the composition ratio of the linear carbonate represented by the formula (II) is 74.0 to 81.9%, and
the composition ratio of the compound represented by the formula (III) is 0.1 to 1.0%, based on the whole solvents (100%), all percentages by volume.

5. A lithium secondary battery according to claim 1,
wherein the gas generating resin includes a gas generating resin that reacts endothermically upon thermal decomposition.

6. A lithium secondary battery according to claim 1,
wherein the gas generating resin includes a gas generating resin that generates carbon dioxide upon thermal decomposition.

7. A lithium secondary battery according to claim 1,
wherein the gas generating resin includes at least two gas generating resins of different types.

8. A lithium secondary battery according to claim 1,
wherein the electroconductive filler includes a carbon material.

9. A lithium secondary battery according to claim 1,
wherein the electroconductive filler includes at least two electroconductive fillers of different types.

10. A lithium secondary battery including a cathode that is capable of storing/releasing a lithium ion and an anode that is capable of storing/releasing a lithium ion formed through a separator that separates the electrodes from each other, and an electrolyte solution,
wherein the lithium secondary battery comprises:
a mechanism for cutting off a current capable of operating in response to an inner pressure of the battery,
the cathode includes a cathode-active material and an electroconductive material, and
the electroconductive material includes a polycarbonate.

11. A lithium secondary battery according to claim 10,
wherein the polycarbonate has a molecular weight of 1,000 to 1,000,000.

12. A lithium secondary battery according to claim 10,
wherein the electroconductive material generates a gas at a temperature between 50° C. and 200° C., inclusive.
